(19) United States
(12) Patent Application Publication
(10) Pub. No.: US 2008/0008176 A1
(43) Pub. Date: Jan. 10, 2008

(54) APPARATUS AND METHOD FOR PROVIDING MULTICAST/BROADCAST SERVICE IN BROADBAND WIRELESS COMMUNICATION SYSTEM

(75) Inventors: Nae-Hyun LIM, Yongin-si (KR); Jun-Hyung Kim, Suwon-si (KR); Yong Chang, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/774,971

(22) Filed: Jul. 9, 2007

(30) Foreign Application Priority Data
Jul. 7, 2006 (KR) 2006-0063790
Aug. 18, 2006 (KR) 2006-0078169
Dec. 12, 2006 (KR) 2006-0126655

(51) Int. Cl. H04L 12/56

(52) U.S. Cl. 370/390

(57) ABSTRACT

Provided is an apparatus and method for providing a Multicast/Broadcast Service MBS service in a broadband wireless communication system. In a method for receiving an MBS service at a user terminal in a broadband wireless communication system, an MBS request message is transmitted to a content server, and an MBS response message including broadcast information is received from the content server. An MBS connection with a base station is established for transmission of contents.

### PRIORITY

This application claims priority under 35 U.S.C. §119(a) to an application filed in the Korean Intellectual Property Office on Jul. 7, 2006 and allocated Serial No. 2006-63790, an application filed in the Korean Intellectual Property Office on Aug. 18, 2006 and allocated Serial No. 2006-78169, an application filed in the Korean Intellectual Property Office on Dec. 12, 2006 and allocated Serial No. 2006-126655, the contents of which are incorporated herein by reference.

### BACKGROUND OF THE INVENTION

1. Field of the Invention

The present invention relates generally to a broadband wireless communication system, and in particular, to an apparatus and method for providing a static mode broadcast service.

2. Description of the Related Art

The existing mobile communication system provides a packet data service to users in a unicast scheme, i.e., an address of a particular user is designated to provide an incoming/outgoing data call, and a band for data transmission is allocated to the corresponding user to provide a service. However, the unicast scheme causes a waste in resources in a network and a radio link, and also causes an increase in system load when the same data is simultaneously transmitted to a plurality of users.

What is therefore proposed is a Multicast/Broadcast Service (MBS) that can provide the existing data service to users desiring to receive the same service simultaneously, while conserving resources. There are two modes, i.e., a static mode and a dynamic mode in the MBS service.

The static mode provides broadcast contents continuously regardless of whether there is a user desiring to receive a broadcast service, i.e., the static mode provides a broadcast service according to the provisioned scheme. Therefore, the static mode does not require a connection establishment process for a broadcast service requested by a user. On the contrary, the dynamic mode requires a connection establishment process for a broadcast service requested by a user, and also requires a connection release process when there is no service-requesting user terminal under a base station for a predetermined period, in order to increase resource efficiency.

Conventional Multicast/Broadcast Service (MBS) services can be classified into a Digital Multimedia Broadcasting (DMB) service and a BroadCast MultiCast Service (BCMCS) in a Code Division Multiple Access (CDMA) network. The DMB service demodulates multimedia signals such as voice signals and image signals in a digital scheme and provides the resulting signals to a stationary receiver or a vehicle portable receiver. The DMB service makes it possible to enjoy high-quality/high-resolution broadcast contents, even on the move, using a Personal Digital Assistant (PDA) or a vehicle terminal, and is thus being regarded as the next-generation broadcast service.

The DMB services can be classified into a terrestrial DMB service and a satellite DMB service. In the terrestrial DMB service, a broadcast program is transmitted over free a Very-High-Frequency (VHF) channel No. 12 or a military channel No. 8 and the corresponding broadcast signal is broadcast through a terrestrial base station to DMB terminals. The terrestrial DMB service is provided free of charge to users. However, the terrestrial DMB service is limited in terms of the number of broadcast channels, and may fail to provide a service in poor environments such as underground. In the satellite DMB service, a broadcast program is transmitted from a satellite DMB broadcasting center to a satellite and the corresponding broadcast signal is broadcast through the satellite to nationwide DMB terminals. The satellite DMB service is a paid-for service. However, the satellite DMB service is superior to the terrestrial DMB service in terms of provision environments and the number of broadcast channels.

The BCMCS in the CDMA network can provide the static/dynamic mode service using the prescribed MBS concepts. However, at present, the BCMCS does not provide a broadcast service, due to the slow acceleration of the CDMA market.

What is therefore required is a new scheme for providing an MBS service in the broadband wireless communication system.

### SUMMARY OF THE INVENTION

An object of the present invention is to substantially solve at least the above problems and/or disadvantages and to provide at least the advantages below. Accordingly, an object of the present invention is to provide an apparatus and method for providing an MBS service in a broadband wireless communication system.

According to one aspect of the present invention, a method for receiving an MBS service at a user terminal in a broadband wireless communication system includes transmitting an MBS request message to a content server and receiving an MBS response message including broadcast information from the content server; and establishing an MBS connection with a base station for transmission of contents.

According to another aspect of the present invention, a method for providing an MBS service at a base station in a broadband wireless communication system includes when a burst reservation request message for an MBS burst is received from an MBS controller, allocating the MBS burst to an MBS traffic transmission period; and establishing an MBS connection with a user terminal for content transmission.

According to still another aspect of the present invention, a method for providing an MBS service at an MBS controller in a broadband wireless communication system includes receiving broadcast information from a content server; allocating an MBS burst on the basis of the received broadcast information; and generating and transmitting a burst reservation request message including MBS burst allocation information to a base station.

According to even another aspect of the present invention, a method for providing an MBS service at a content server in a broadband wireless communication system includes when contents are received from a content provider, generating a service guide using the received contents; when an MBS request message is received from a user terminal, transmitting an MBS response message including the generated service guide to the user terminal; and when a content request message for one or more contents is received from the user terminal, transmitting the corresponding contents to an MBS controller.

According to yet another aspect of the present invention, an apparatus for providing an MBS service in a broadband wireless communication system includes a user terminal that transmits/receives an MBS request message/an MBS response message and establishes an MBS connection with a base station for content transmission; and a content server that, upon receiving contents from a content provider, generates a service guide using the received contents and, upon receiving the MBS request message from the user terminal, performs user authentication and service registration on the user terminal and then transmits the MBS response message including the generated service guide to the user terminal.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a broadband wireless communication system according to an embodiment of the present invention;

FIG. 2 is a flow diagram illustrating an overall signaling procedure for providing an MBS service in the broadband wireless communication system according to a first embodiment of the present invention;

FIG. 3 is a diagram illustrating the format of a frame transmitted wirelessly according to an embodiment of the present invention;

FIG. 4 is a flowchart illustrating a procedure for receiving an MBS service at a user terminal in the broadband wireless communication system according to the first embodiment of the present invention;

FIG. 5 is a flowchart illustrating a procedure for providing an MBS service at a base station in the broadband wireless communication system according to the first embodiment of the present invention;

FIG. 6 is a flowchart illustrating a procedure for providing an MBS service at an MBS controller in the broadband wireless communication system according to the first embodiment of the present invention;

FIG. 7 is a flowchart illustrating a procedure for providing an MBS service at a content server in the broadband wireless communication system according to the first embodiment of the present invention;

FIGS. 8A and 8B are flow diagrams illustrating an overall signaling procedure for providing an MBS service in the broadband wireless communication system according to a second embodiment of the present invention;

FIG. 9 is a flowchart illustrating a procedure for receiving an MBS service at a user terminal in the broadband wireless communication system according to the second embodiment of the present invention;

FIG. 10 is a flowchart illustrating a procedure for providing an MBS service at a base station in the broadband wireless communication system according to the second embodiment of the present invention;

FIG. 11 is a flowchart illustrating a procedure for providing an MBS service at an MBS controller in the broadband wireless communication system according to the second embodiment of the present invention; and

FIG. 12 is a flowchart illustrating a procedure for providing an MBS service at a content server in the broadband wireless communication system according to the second embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for providing an MBS service in a broadband wireless communication system.

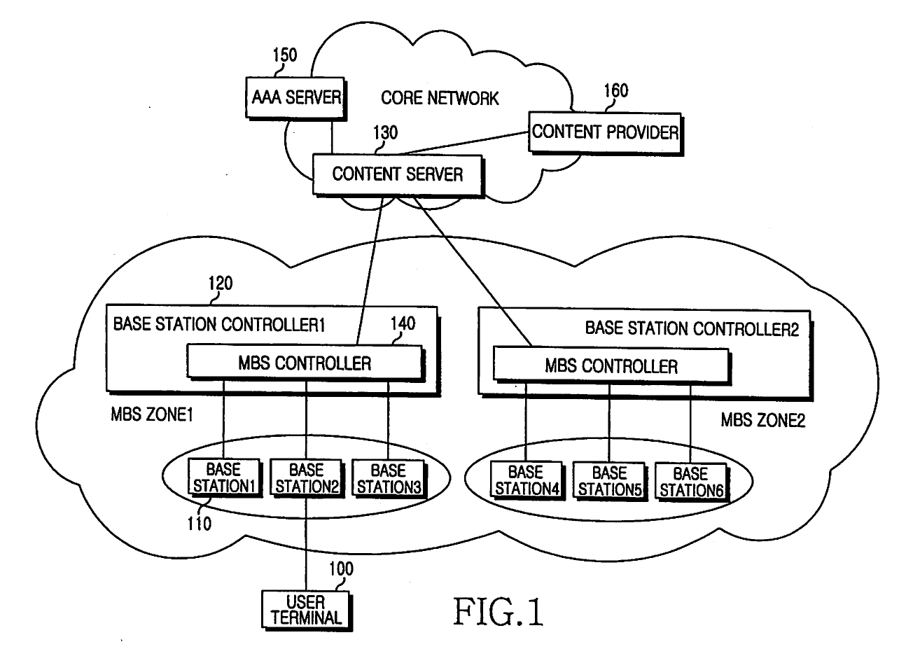

FIG. 1 is a block diagram of a broadband wireless communication system according to an embodiment of the present invention.

Referring to FIG. 1, the broadband wireless communication system includes a user terminal 100, a base station 110, a base station controller 120, a content server 130, an MBS controller 140, an Authentication, Authorization, and Accounting (AAA) server 150, and a content provider 160.

The content provider 160 generates contents for an actual broadcast service to be broadcast to the user terminal 100, and provides the generated broadcast contents to the content server 130. The AAA server 150 is connected to the content server 130 and manages AAA information of the user terminal 100 that requests an MBS service.

The content server 130 stores the broadcast contents received from the content server 160, and serves as an application program server for providing an MBS service. In addition, the content server 130 manages MBS users, generates a service guide containing a variety of information such as a broadcast schedule, broadcast contents, and content providers, and performs accounting and encryption for broadcast contents.

The MBS controller 140 may be included in the base station controller 120. The MBS controller 140 manages an MBS zone allocated by the content server 130, allocates a multicast Connection IDentification (CID) and an MBS burst, and manages the corresponding allocation information. In addition, the MBS controller 140 performs packetization for data synchronization between base stations and time stamping for time synchronization. Alternatively, the MBS zone may be managed by the content server 130.

The base station 110 loads broadcast contents on the MBS burst allocated by the MBS controller 140 and transmits the broadcast contents to the user terminal 100 that is located in a coverage cell of the base station 110.

A control message transmission path and a traffic transmission path between the respective network components illustrated in FIG. 1 are as follows: For example, contents are stored in the content server 130 after being generated by the content provider 160, are transmitted to one or more base stations 110 after being packetized and time-stamped by the MBS controller 140 in the base station controller 120, and are broadcast by the base stations 110 to the user terminals 100 in the MBS zone. For control of respective network components on the traffic transmission path, the content server 130 generates a control message and transmits the control message to the MBS controller 140. To control the base stations 110, the MBS controller 140 generates a control message and transmits the control message to the base stations 110. For control of user terminals 100 in the MBS zone, the base stations 110 generate a control message and transmit the control message to the user terminals 100.

A description will now be given of a method for providing an MBS service in the broadband wireless communication system according to a first embodiment of the present invention.

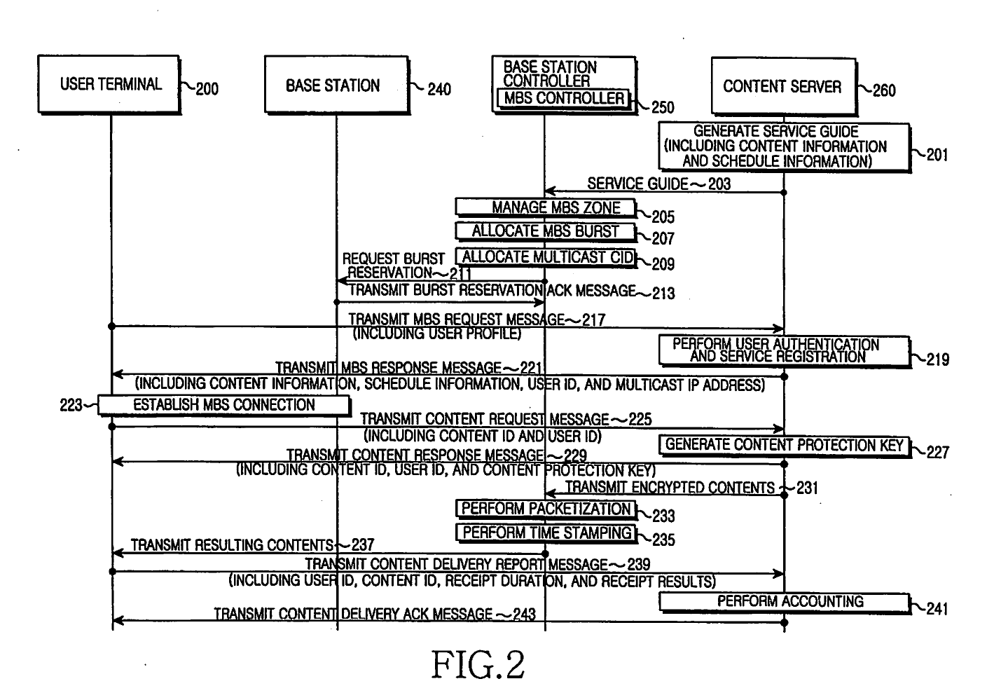

FIG. 2 is a flow diagram illustrating an overall signaling procedure for providing an MBS service in the broadband wireless communication system according to the first embodiment of the present invention.

Referring to FIG. 2, a content server 260 receives a content file from a content provider and stores the received content file in its own file storage. In step 201, the content server 260 generates a service guide using the content file received from the content provider. In step 203, the content server 260 transmits the generated service guide to an MBS controller 250 in a base station controller. For example, the service guide contains information about a broadcast schedule, contents, and content providers.

An example of the information contained in the service guide is shown in Table 1 below.

TABLE 1

| Zone ID | Information | Value | Note |
|---|---|---|---|
| File 1 | Content ID | 0x0001 | Content ID number |
| | Channel ID | MBC | Channel number for broadcasting contents |
| | Content | 9 O'clock News | Name of broadcast transmitted to user |
| | Name | | |
| | Start Time | 21:00:00:00 | Broadcast start time |
| | Transmission | 00:52:00:00 | Broadcast transmission time |
| | Time | | |
| | Multicast IP | 0xMBC_IP | Multicast IP addresses of user terminals that |
| | Address | | receive corresponding contents. |
| | Multicast | CID_MBC-News | Multicast connection ID that is used by user |
| | Connection | | terminal to decode MBS burst of |
| | ID | | corresponding contents at user terminal. |
| | Start Frame | 1200 | Frame number that is transmitted from MBS |
| | Number | | controller to all base stations in MBS zone |
| | | | for time synchronization. |
| | Burst | Symbol Offset, | Allocation period and MBS burst allocation |
| | Allocation | Subchannel Offset, | information for contents |
| | Information | Number of Symbols, | |
| | | Number of Subchannels, | |
| | | Repetition/Allocation Period | |
| | Packet Size | 1500 bytes | Size of packetization to be transmitted on |
| | | | MBS burst frame. |
| | Accounting | 500 Won | Accounting information of corresponding |
| | Information | | contents |
| File 2 | . . . | . . . | . . . |

The service guide transmitted from the content server 260 to the MBS controller 250 may contain all information of the service guide generated by the content server 260, or may contain only a portion of all the information of the generated service guide, which is needed by the MBS controller 250 and a base station 240 to provide an MBS service.

In step 205, the MBS controller 250 manages an MBS zone for base stations 240 that are managed by the MBS controller 250, i.e., the MBS controller 250 performs operation information management and maintenance for the base stations 240 that are managed by the MBS controller 250. In step 207, on the basis of the service guide received from the content server 260, the MBS controller 250 allocates an MBS burst to the base stations 240 and generates MBS burst allocation information. In step 209, the MBS controller 250 allocates a multicast CID for each of the contents and manages the same. The MBS burst is used by all the base stations to transmit the same contents in the same period.

In step 211, the MBS controller 250 requests an allocation of a DownLink (DL) frame burst for the MBS service by transmitting a burst reservation request message including the MBS burst allocation information to the base stations 240. For example, the MBS burst allocation information includes information about an MBS burst frame offset, information about the start of a frame number for transmission of an MBS burst, and MBS frame duration information (if necessary). For example, the burst reservation request message may further include a multicast CID allocated to the corresponding contents and the service guide received from the content server 260.

Thereafter, in response to the burst reservation request message received from the MBS controller 250, the base stations 240 allocate an MBS traffic transmission period for transmission of broadcast contents. In step 213, the base stations 240 transmit a burst reservation ACKnowledgement (ACK) message to the MBS controller 250, i.e., the base stations 240 make a reservation for use of a frame burst requested to be allocated, and transmit a completion message for the reservation.

In step 217, when a user makes a request to receive an MBS service, a user terminal 200 transmits an MBS request message including user profile information to the content server 260. In step 219, the content server 260 uses the user profile information to perform a user authentication process to determine whether the user of the user terminal 200 is authorized to receive the MBS service, and upon completion of the user authentication process, and the content server 260 performs a service registration process to store the user information in a database in order to provide the MBS service to the user terminal 200. The user authentication process can be performed in conjunction with the AAA server 150 (see FIG. 1). In step 221, the content server 260 transmits an MBS response message to the user terminal 200. The MBS response message includes a service guide containing broadcast information (e.g., content information and schedule information) provided in a corresponding broadcast zone, a user IDentification (ID), and a multicast Internet Protocol (IP) address mapped to a corresponding broadcast channel. The service guide transmitted from the content server 260 to the user terminal 200 may contain all information of the service guide generated by the content server 260, or may contain only a portion (e.g., accounting information, a content name, and a multicast IP address) of all the information of the generated service guide, which is needed by the user terminal 200 to receive an MBS service.

Upon receiving the MBS response message, the user terminal 200 uses a user terminal-initiated Dynamic Service Addition (DSA) process to establish an MBS connection with the base station 240 for an MBS traffic transmission, in step 223. Thereafter, when the user selects desired contents using the information of the service guide, the user terminal 200 transmits a content request message including the user ID and the selected content ID to the content server 260, in step 225.

In step 227, the content server 260 encrypts the selected contents and generates a content protection key for decrypting the encrypted contents. In step 229, the content server 260 transmits a content response message including the generated content protection key, the user ID, and the content ID to the user terminal 200. In step 231, the content server 260 transmits the encrypted contents to the MBS controller 250. Herein, the encrypted contents may be transmitted before step 229, and one or more contents may be transmitted according to the user's selection.

In step 233, the MBS controller 250 performs packetization for data synchronization on the encrypted contents received from the content server 260. In step 235, the MBS controller 250 performs time stamping for time synchronization on the packetized contents. In step 237, the MBS controller 250 transmits the packetized and time-stamped contents to the user terminal 200.

Upon receiving the contents from the MBS controller 250, the user terminal 200 decodes the received contents using the content protection key. In step 239, the user terminal 200 transmits a content delivery report message for reporting the completion of the content receipt to the content server 260. The content delivery report message includes accounting data, and examples of the accounting data include information about the user ID, the content ID, the broadcast receipt duration, and the receipt results indicating whether the contents have been normally received. If a portion of the contents has been abnormally received, the user terminal 200 transmits a retransmission request message to the content server 260.

In step 241, the content server 260 performs accounting for the MBS service on the basis of the information included in the content delivery report message. In step 243, the content server 260 transmits a content delivery ACK message for the content delivery report to the user terminal 200 to inform the user terminal 200 of the successful completion of the MBS service.

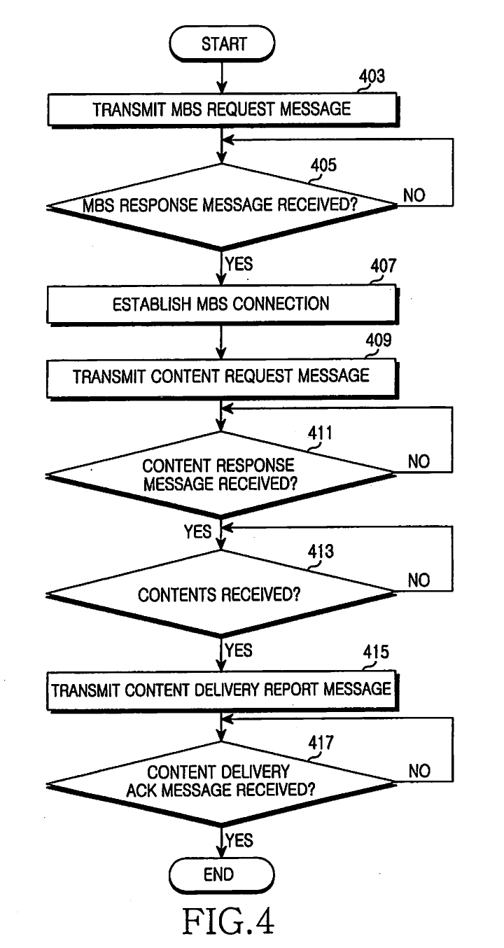

FIG. 4 is a flowchart illustrating a procedure for receiving an MBS service at the user terminal 200 in the broadband wireless communication system according to the first embodiment of the present invention.

Referring to FIG. 4, when the user makes a request to receive an MBS service, the user terminal 200 transmits an MBS request message to the content server 260 in step 403. The MBS request message includes user profile information, and is used by the user terminal 200 to request an MBS registration in order to receive an MBS service provided in a corresponding broadcast zone.

In step 405, the user terminal 200 determines whether an MBS response message is received from the content server 260. The MBS response message includes a service guide containing broadcast information (e.g., content information and schedule information) provided in the corresponding broadcast zone, a user IDentification (ID), and a multicast IP address mapped to a corresponding broadcast channel. The service guide transmitted from the content server 260 to the user terminal 200 may contain all information of the service guide generated by the content server 260, or may contain only a portion (e.g., accounting information, a content name, and a multicast IP address) of all the information of the generated service guide, which is needed by the user terminal 200 to receive an MBS service.

Upon receiving the MBS response message, the user terminal 200 establishes an MBS connection with the base station 240 for an MBS traffic transmission, in step 407. The MBS connection may be established as follows: First, the user terminal 200 transmits a DSA request message including the multicast IP address to the base station 240 in order to obtain a multicast CID for a corresponding broadcast channel. Then, the base station 240 managing a mapping table of a multicast CID and the multicast IP address transmits, to the user terminal 200, a DSA response message including a multicast CID mapped to the multicast IP address received from the user terminal 200, thereby establishing the MBS connection.

In step 409, when the user selects desired broadcast contents using the information of the service guide, the user terminal 200 transmits a content request message including the selected content ID and the user ID to the content server 260 to request a transmission of the desired broadcast contents. At this point, the communication between the user terminal 200 and the content server 260 is performed through application signaling.

In step 411, the user terminal 200 determines whether a content response message including the user ID, the content ID, and a content protection key for decrypting the broadcast contents is received from the content server 260. If the content response message is received from the content server 260, the procedure proceeds to step 413. In step 413, the user terminal 200 determines whether encrypted contents obtained through packetization time stamping are received from the MBS controller 250. If the encrypted contents are received from the MBS controller 250, the procedure proceeds to step 415. In step 415, the user terminal 200 transmits a content delivery report message for reporting the completion of the content receipt to the content server 260. The content delivery report message includes accounting data, and examples of the accounting data include information about the user ID, the content ID, the broadcast receipt duration, and the receipt results indicating whether the contents have been normally received. At this point, the user terminal 200 decrypts the encrypted contents using the content protection key and provides the corresponding broadcast contents to the user.

In step 417, the user terminal 200 determines whether a content delivery ACK message for the content delivery report is received from the content server 260. If the content delivery ACK message is received from the content server 260, the procedure ends.

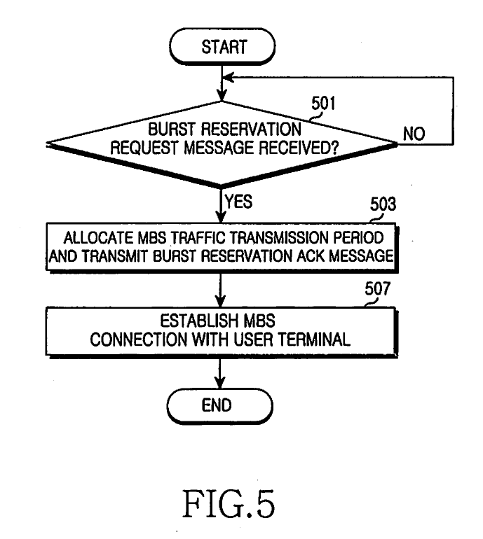

FIG. 5 is a flowchart illustrating a procedure for providing an MBS service at the base station 240 in the broadband wireless communication system according to the first embodiment of the present invention.

Referring to FIG. 5, the base station 240 determines whether a burst reservation request message is received from the MBS controller 250, in step 501.

An example of the format of the burst reservation request message is shown in Table 2 below.

TABLE 2

| Syntax | Size | Notes |
|---|---|---|
| OFDMA Symbol Offset | 8 bits | OFDMA symbol offset with respect to start of next |
| | | (MBS Burst Frame Offset + 2)th frame |
| Subchannel Offset | 6 bits | OFDMA subchannel offset wit respect to start of the |
| | | next (MBS Burst Frame Offset + 2)th frame |
| Boosting | 3 bits | Refer to Table 273 |
| No. OFDMA Symbols | 7 bits | The size of MBS data |
| No. Subchannels | 6 bits | |
| Repetition Coding Indication | 2 bits | 0b00 - No repetition coding |
| | | 0b01 - Repetition coding of 2 used |
| | | 0b10 - Repetition coding of 4 used |
| | | 0b11 - Repetition coding of 6 used |
| Start of Frame Number | z | Frame number in which MBS Burst is included |
| Duration of Frame | | |

As shown in Table 2, the burst reservation request message includes information about Orthogonal Frequency Division Multiple Access (OFDMA) Symbol Offset indicating the start point of an OFDMA symbol of an allocated MBS burst, Subchannel Offset indicating the start index number of a subchannel for transmitting an MBS burst, Boosting Data, No. OFDMA Symbols indicating the number of OFDMA symbols occupied by an MBS burst to be transmitted, No. Subchannels indicting the number of subchannels for transmitting an MBS burst, Repetition Coding Indication, Start of Frame Number indicating a frame number for transmitting an MBS burst, and Duration of Frame (if necessary). The burst reservation request message may further include a multicast CID allocated to the corresponding contents, and a service guide transmitted from the content server 260 to the MBS controller 250.

If the burst reservation request message is received from the MBS controller 250, the base station 240 allocates a transmission period for an MBS traffic transmission and transmits a burst reservation ACK message to the MBS controller 250 to report the completion of the reservation for the requested (allocated) period, in step 503.

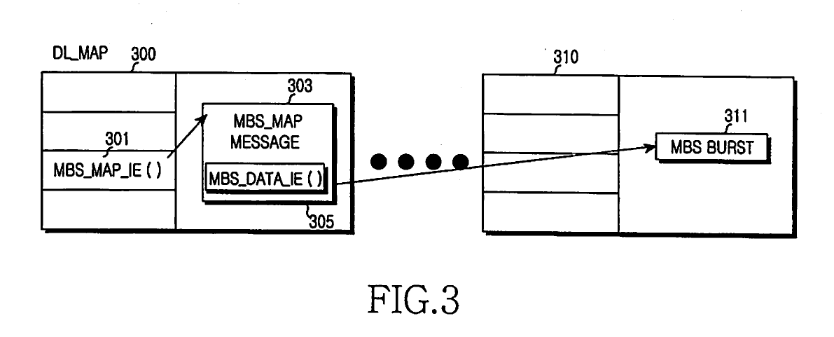

An example of the format of the frame transmitted wirelessly will now be described with reference to FIG. 3.

Referring to FIG. 3, upon receiving a frame, the user terminal checks a DL_MAP 300 to detect the contents of a subframe. An MBS Mobile Access Protocol Information Element (MBS_MAP_IE( )) 301 in the DL_MAP 300 indicates the location of an MBS_MAP message 303, and an MBS_DATA_IE( ) 305 in the MBS_MAP message 303 indicates the location of an MBS burst 311 to be transmitted. The MBS burst 311 may be included after 2 to 5 or more frames from the frame of the MBS_MAP message 303.

The reason for allocating the period of the MBS burst 311 uniformly as described above is to provide a macro diversity gain of the MBS traffic. The macro diversity gain is a gain that is provided by a signal amplification when a user terminal receives the same signal from two or more base stations at the same time. For example, when a user terminal is located at the boundary between two or more cells, the user terminal receives signals from two or more base stations covering the two or more cells. In this case, the signals received from the two or more base stations are different in terms of arrival time and received data, and the received signals other than the most strongly received signal create an attenuation effect, i.e., when a user terminal receives two or more signals at different times and positions, the user terminal treats the received signals, other than the most strongly received signal, as interference signals. However, as described above, when an MBS burst period is uniformly allocated to a user terminal, which is located at the boundary between two or more cells, to allow the user terminal to receive the same signal from two or more base stations at the same time, the user terminal can receive a signal amplified by a few times. In addition, the same multicast ID must be used in order to provide a macro diversity gain in the same broadcast zone. Therefore, the burst reservation request message must include a rule for mapping between a multicast IP address and a multicast CID.

In step 507, the base station 240 establishes an MBS connection with the user terminal 200 through a DSA process, as described with reference to FIG. 4. Thereafter, the procedure ends.

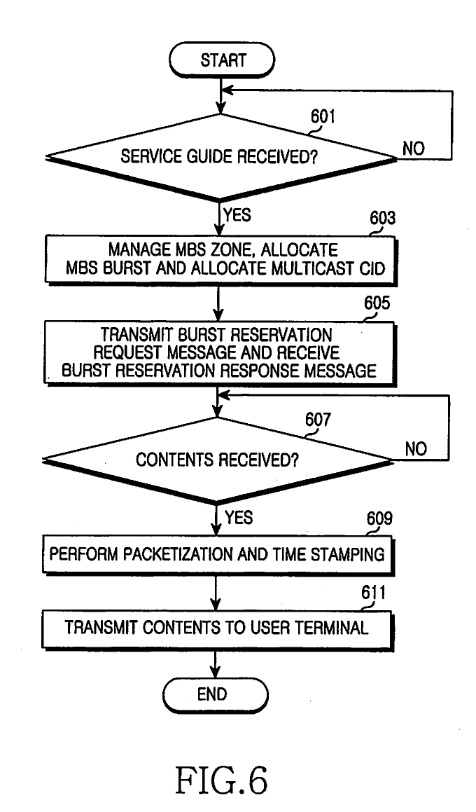

FIG. 6 is a flowchart illustrating a procedure for providing an MBS service at the MBS controller 250 in the broadband wireless communication system according to the first embodiment of the present invention.

Referring to FIG. 6, the MBS controller 250 determines whether a service guide is received from the content server 260, in step 601. The service guide may be configured as shown in Table 1. The service guide transmitted from the content server 260 to the MBS controller 250 may contain all information of the service guide generated by the content server 260, or may contain only a portion of all the information of the generated service guide, which is needed by the MBS controller 250 and the base station 240 to provide an MBS service.

If the service guide is received from the content server 260, the MBS controller 250 manages an MBS zone for base stations 240 that are managed by the MBS controller 250, in step 603, i.e., the MBS controller 250 performs operation information management and maintenance for the base stations 240 that are managed by the MBS controller 250. In addition, on the basis of the service guide received from the content server 260, the MBS controller 250 allocates an MBS burst to the base stations 240, generates MBS burst allocation information, allocates a multicast CID for each of the contents, and manages the same.

In step 605, by transmitting a burst reservation request message including the MBS burst allocation information to the base stations 240, the MBS controller 250 requests an allocation of a DL frame burst for the MBS service and receives a burst reservation ACK message from the base stations 240. For example, the burst reservation request message may be formatted as in shown Table 2, and may further include a multicast CID allocated to the corresponding contents and the service guide received from the content server 260.

In step 607, the MBS controller 250 determines whether encrypted contents are received from the content server 260. If the encrypted contents are received, the procedure proceeds to step 609. In step 609, the MBS controller 250 performs packetization for data synchronization on the encrypted contents and performs time stamping for time synchronization on the packetized contents. In step 611, the MBS controller 250 transmits the packetized and time-stamped contents to the user terminal 200. Thereafter, the procedure ends.

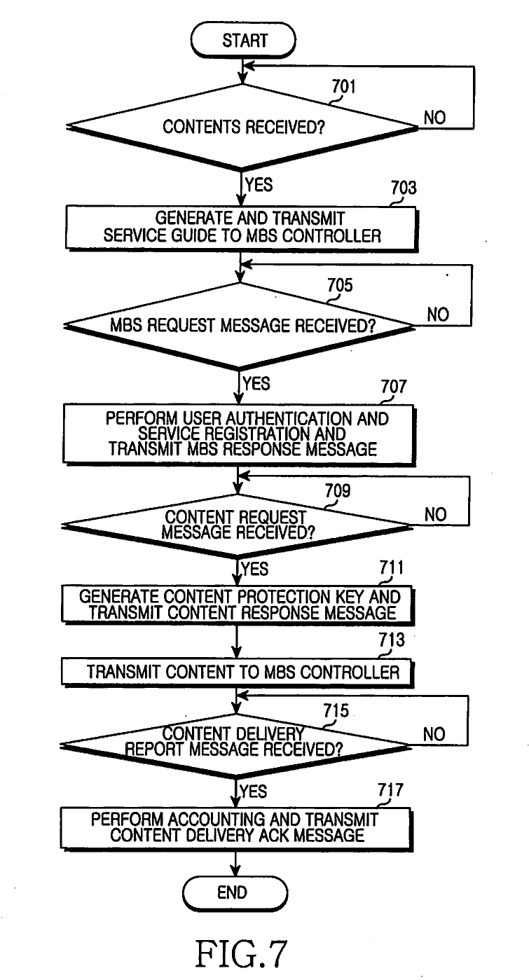

FIG. 7 is a flowchart illustrating a procedure for providing an MBS service at the content server 260 in the broadband wireless communication system according to the first embodiment of the present invention.

Referring to FIG. 7, the content server 260 determines whether broadcast contents are received from a content provider, in step 701. If the contents are received, the content server 260 stores the received content file in its own file storage. In step 703, the content server 260 generates a service guide using the content file received from the content provider and transmits the generated service guide to the MBS controller 250. For example, the service guide may be configured as shown in Table 1 above. The service guide transmitted from the content server 260 to the MBS controller 250 may contain all the information of the generated service guide, or may contain only a portion of all the information of the generated service guide, which is needed by the MBS controller 250 and the base station 240 to provide an MBS service.

In step 705, the content server 260 determines whether an MBS request message including user profile information is received from the user terminal 200. If the MBS request message is received, the procedure proceeds to step 707. In step 707, the content server 260 uses the user profile information to perform a user authentication process to determine whether the user of the user terminal 200 is authorized to receive the MBS service, and upon completion of the user authentication process, performs a service registration process to store the user information in a database in order to provide the MBS service to the user terminal 200, and transmits an MBS response message to the user terminal 200. The MBS response message includes a service guide containing broadcast information (e.g., content information and schedule information) provided in a corresponding broadcast zone, a user IDentification (ID), and a multicast IP address mapped to a corresponding broadcast channel. The service guide transmitted from the content server 260 to the user terminal 200 may contain all information of the service guide generated by the content server 260, or may contain only a portion (e.g., accounting information, a content name, and a multicast IP address) of all the information of the generated service guide, which is needed by the user terminal 200 to receive an MBS service.

In step 709, the content server 260 determines whether a content request message including a content ID and a user ID is received from the user terminal 200. If the content request message is received, the procedure proceeds to step 711. In step 711, the content server 260 encrypts the corresponding contents, generates a content protection key for decrypting the encrypted contents, and transmits a content response message including the generated content protection key, the user ID, and the content ID to the user terminal 200. In step 713, the content server 260 transmits the encrypted contents to the MBS controller 250.

In step 715, the content server 260 determines whether a content delivery report message for reporting the completion of the content receipt is received from the user terminal 200. The content delivery report message includes accounting data, and examples of the accounting data include information about the user ID, the content ID, the broadcast receipt duration, and the receipt results indicating whether the contents have been normally received. If the content deliver report message is received from the user terminal 200, the procedure proceeds to step 717. In step 717, the content server 260 performs accounting for the MBS service on the basis of the information included in the content delivery report message, and transmits a content delivery ACK message for the content delivery report to the user terminal 200 to inform the user terminal 200 of the successful completion of the MBS service. Thereafter, the procedure ends.

In the above-described method for providing an MBS service in the broadband wireless communication system according to the first embodiment of the present invention, the user terminal-initiated DSA process is used to perform service initiation. Alternatively, a base station-initiated DSA process may be used to perform the service initiation.

Hereinafter, a description will be given of a method for providing an MBS service in the broadband wireless communication system according to a second embodiment of the present invention, in which a base station-initiated DSA process is used to perform service initiation.

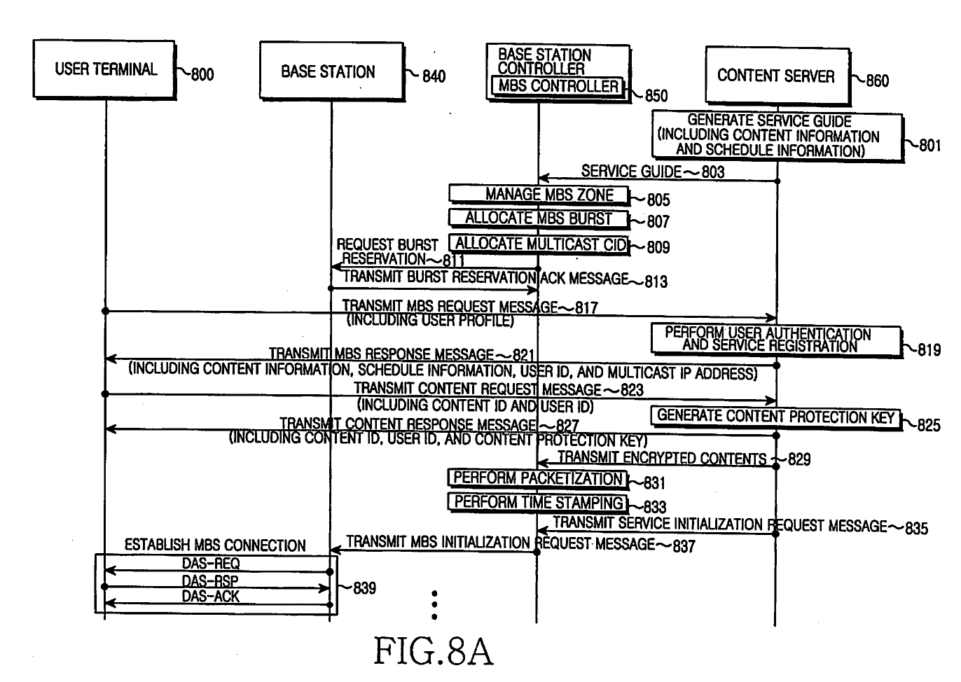

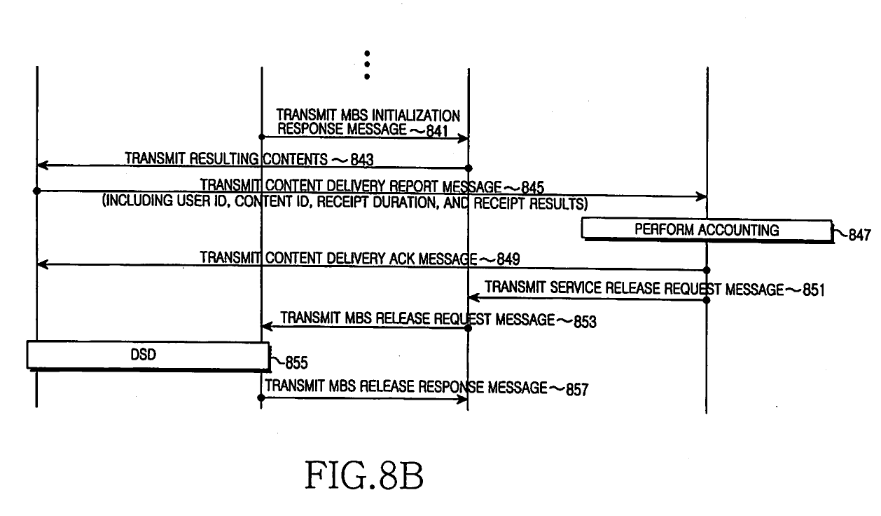

FIGS. 8A and 8B are flow diagrams illustrating an overall signaling procedure for providing an MBS service in the broadband wireless communication system according to the second embodiment of the present invention.

Steps 801 through 821 in FIG. 8A are identical respectively to steps 201 through 221 in FIG. 2 and thus a description of steps 801 through 821 will be omitted for conciseness.

Referring to FIG. 8A, when a user of a user terminal 800 selects desired contents using information of a service guide, the user terminal 800 transmits a content request message including the selected content ID and the user ID to a content server 860 in step 823. In step 825, the content server 860 encrypts the selected contents and generates a content protection key for decrypting the encrypted contents. In step 827, the content server 860 transmits a content response message including the generated content protection key, the user ID, and the content ID to the user terminal 800. In step 829, the content server 860 transmits the encrypted contents to an MBS controller 850. Herein, the encrypted contents may be transmitted before step 827, and one or more contents may be transmitted according to the user's selection.

In step 831, the MBS controller 850 performs packetization for data synchronization on the encrypted contents received from the content server 860. In step 833, the MBS controller 850 performs time stamping for time synchronization on the packetized contents. In step 835, the content server 860 transmits a service initiation request message to the MBS controller 850 so that the user can be provided with actual broadcast contents. In step 837, in response to the service initiation request message received from the content server 860, the MBS controller 850 transmits an MBS initiation request message to a base station 840 to request the base station 840 to establish a connection with the user terminal 800 so that the user terminal 800 can receive a content traffic from the base station 840.

Upon receiving the MBS initiation request message, the base station 840 establishes an MBS connection with the user terminal 800 in step 839. The MBS connection with the user terminal 800 may be established by transmitting a DSA REQuest message (DSA-REQ) including a multicast CID allocated to the corresponding contents from the base station 840 to the user terminal 800 to initiate MBS connection initiation, transmitting a DSA ReSPonse message (DSA-RSP) from the user terminal 800 received the DSA request message to the base station 840, and transmitting a DSA ACK message (DSA-ACK) from the base station 840 received the DSA response message to the user terminal 800. Upon completion of the establishment of the MBS connection with the user terminal 800, the base station 840 transmits an MBS initiation response message to the MBS controller 850 to inform the MBS controller 850 that the preparations for an MBS service are complete, in step 841. In step 843, the MBS controller 850 transmits the packetized and time-stamped contents to the user terminal 800.

Upon receiving the contents from the MBS controller 850, the user terminal 800 decodes the received contents using the content protection key. In step 845, the user terminal 800 transmits a content delivery report message for reporting the completion of the content receipt to the content server 860. The content delivery report message includes accounting data, and examples of the accounting data include information about the user ID, the content ID, the broadcast receipt duration, and the receipt results indicating whether the contents have been normally received. If a portion of the contents has been abnormally received, the user terminal 800 transmits a retransmission request message to the content server 860.

In step 847, the content server 860 performs accounting for the MBS service on the basis of the information included in the content delivery report message. In step 849, the content server 860 transmits a content delivery ACK message for the content delivery report to the user terminal 800 to inform the user terminal 800 of the successful completion of the MBS service.

In step 851, the content server 850 transmits a service release request message to the MBS controller 850 to request the MBS controller 850 to terminate the MBS service. After termination of the MBS service, the MBS controller 850 transmits an MBS release request message to the base station 840 in order to release the MBS connection between the base station 840 and the user terminal 800, in step 853. Upon receiving the MBS release request message, the base station 840 releases the MBS connection with the user terminal 800 through a Dynamic Service Deletion (DSD) process, in step 855. In step 857, the base station 840 transmits an MBS release response message to the MBS controller 850 to completely terminate the MBS service for the user.

As described above, the base station-initiated DSA process can be used to perform the service initiation, when the user's response provides a necessary service. For example, when an MBS service is used to request the user to select one of two or more candidate contents and simultaneously an MBS connection is established, the user terminal can receive the MBS service and simultaneously transmit/report the selected contents through the established MBS connection.

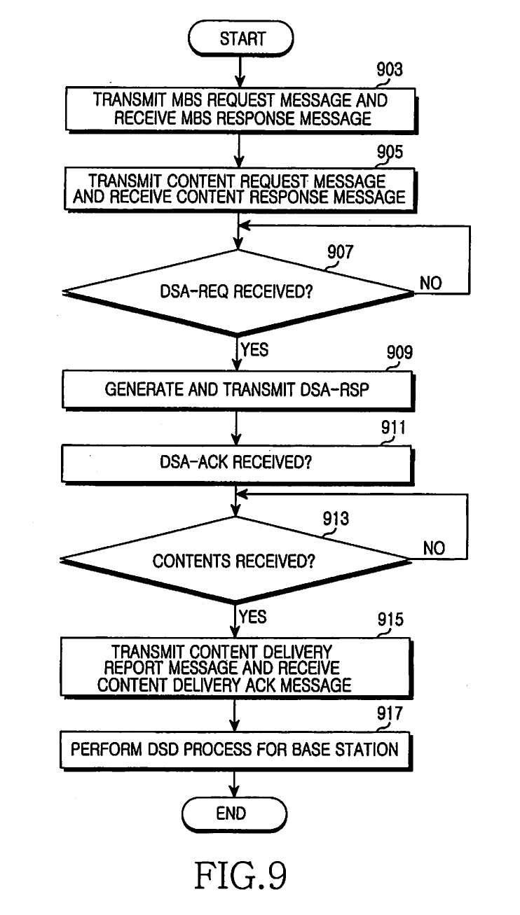

FIG. 9 is a flowchart illustrating a procedure for receiving an MBS service at the user terminal 800 in the broadband wireless communication system according to the second embodiment of the present invention.

Referring to FIG. 9, when the user makes a request to receive an MBS service, the user terminal 800 transmits an MBS request message to the content server 860 and receives an MBS response message from the content server 860, in step 903. The MBS request message includes user profile information, and is used by the user terminal 800 to request an MBS registration in order to receive an MBS service provided in a corresponding broadcast zone. The MBS response message includes a service guide containing broadcast information (e.g., content information and schedule information) provided in the corresponding broadcast zone, a user IDentification (ID), and a multicast IP address mapped to a corresponding broadcast channel. The service guide transmitted from the content server 860 to the user terminal 800 may contain all information of the service guide generated by the content server 860, or may contain only a portion (e.g., accounting information, a content name, and a multicast IP address) of all the information of the generated service guide, which is needed by the user terminal 800 to receive the MBS service.

Thereafter, when the user selects desired contents using the information of the service guide, the user terminal 800 transmits a content request message including the selected content ID and the user ID to the content server 860 to request a transmission of the corresponding broadcast contents and receives a content response message including the content protection key for the broadcast contents, the user ID, and the content ID, in step 905.

In step 907, the user terminal 800 determines whether a DSA request message for an MBS connection establishment is received from the base station 840. The DSA request message includes a multicast CID mapped to the corresponding contents. If the DSA request message is received from the base station 840, the user terminal 800 generates a DSA response message and transmits the generated DSA response message to the base station 840, in step 909. In step 911, the user terminal 800 receives a DSA ACK message from the base station 840 to complete the MBS connection establishment. In step 913, the user terminal 800 determines whether encrypted contents obtained through packetization and time stamping are received from the MBS controller 850.

If the encrypted contents are received from the MBS controller 850, the user terminal 800 transmits a content delivery report message for reporting the completion of the content receipt to the content server 860 and receives a content delivery ACK message from the content server 860, in step 915. The content delivery report message includes accounting data, and examples of the accounting data include information about the user ID, the content ID, the broadcast receipt duration, and the receipt results indicating whether the contents have been normally received. At this point, the user terminal 800 may decrypt the encrypted contents using the content protection key and provide the corresponding broadcast contents to the user.

In step 917, the user terminal 800 releases the MBS connection with the base station 840 through a DSD process. Thereafter, the procedure ends.

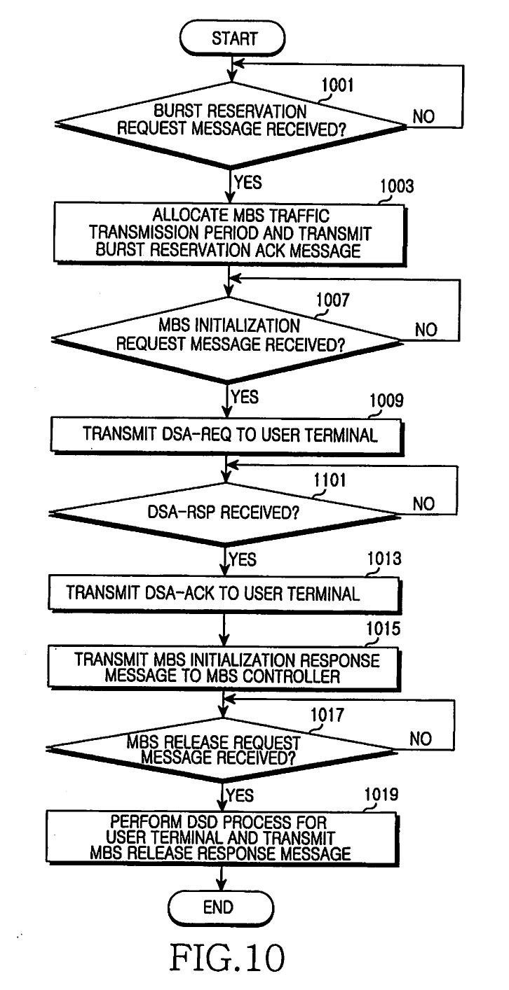

FIG. 10 is a flowchart illustrating a procedure for providing an MBS service at the base station 840 in the broadband wireless communication system according to the second embodiment of the present invention.

Referring to FIG. 10, the base station 840 determines whether a burst reservation request message is received from the MBS controller 850, in step 1001. The burst reservation request message may be formatted as shown in Table 2. The burst reservation request message may further include a multicast CID allocated to the corresponding contents, and a service guide transmitted from the content server 860 to the MBS controller 850.

If the burst reservation request message is received from the MBS controller 850, the base station 840 allocates a transmission period for an MBS traffic transmission and transmits a burst reservation ACK message to the MBS controller 850 to report the completion of the reservation for the requested (allocated) period, in step 1003.

In step 1007, the base station 840 determines whether an MBS initiation request message is received from the MBS controller 850. If the MBS initiation request message is received from the MBS controller 850, the base station 840 transmits a DSA request message including a multicast CID allocated to the corresponding contents to the user terminal 800 to initialize MBS connection initiation, in step 1009. In step 1011, the base station 840 determines whether a DSA response message is received from the user terminal 800. If the DSA response message is received from the user terminal 800, the base station 840 transmits a DSA ACK message to the user terminal 800 in step 1013. Consequently, the base station 840 can complete the MBS connection with the user terminal 800. In step 1015, the base station 840 transmits an MBS initiation response message to the MBS controller 850 to inform that the preparations for the MBS service are complete.

In step 1017, the base station 840 determines whether an MBS release request message is received from the MBS controller 850. If the MBS release request message is received from the MBS controller 850, the base station 840 releases the MBS connection with the user terminal 800 through a DSD process and transmits an MBS release response message to the MBS controller 850, in step 1019. Therefore, the procedure ends.

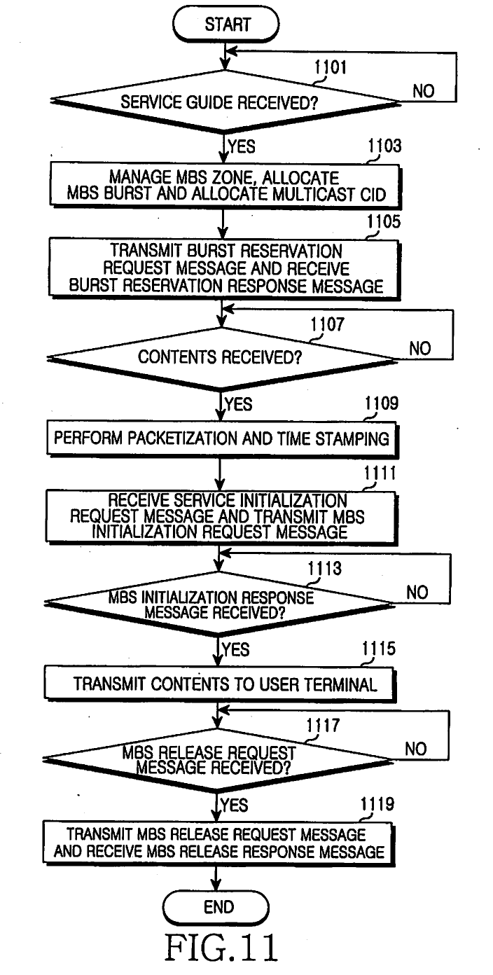

FIG. 11 is a flowchart illustrating a procedure for providing an MBS service at the MBS controller 850 in the broadband wireless communication system according to the second embodiment of the present invention.

Steps 1101 through 1109 in FIG. 11 are identical respectively to steps 601 through 609 in FIG. 6 and thus a description of steps 1101 through 1109 will be omitted for conciseness.

Referring to FIG. 11, the MBS controller 850 receives a service initiation request message from the content server 860 and transmits an MBS initiation request message to the base station 840 to request the base station 840 to establish an MBS connection with the user terminal 800 so that the user terminal 800 can receive a content traffic from the base station 840, in step 1111.

In step 1113, the MBS controller 850 determines whether an MBS initiation response message is received from the base station 840. If the MBS initiation response message is received from the base station 840, the MBS controller 850 transmits packetized and time-stamped contents to the user terminal 800, in step 1115.

In step 1117, the MBS controller 850 determines whether a service release request message is received from the content server 860. If the service release request message is received from the content server 860, the MBS controller 850 terminates the corresponding service, transmits an MBS release request message to the base station 840 to release the MBS connection between the base station 840 and the user terminal 800, and receives an MBS release response message from the base station 840, in step 1119. Thereafter, the procedure ends.

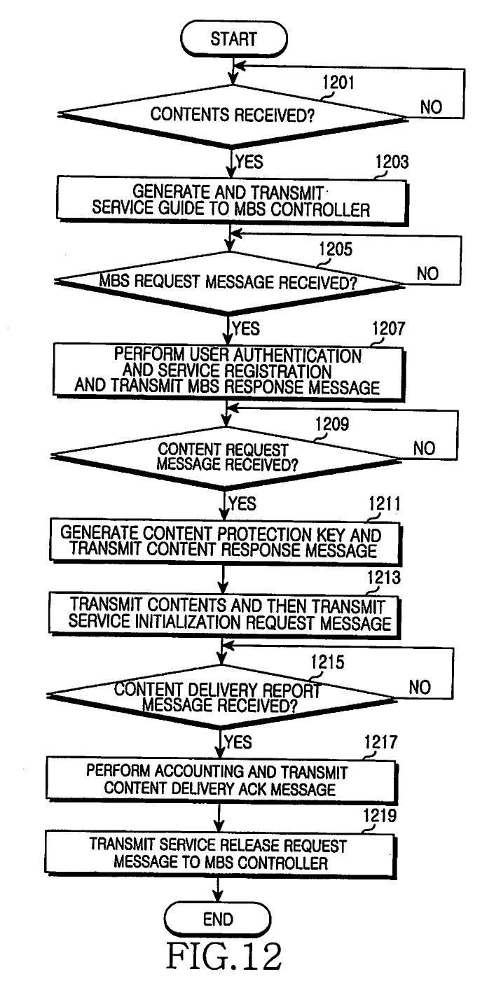

FIG. 12 is a flowchart illustrating a procedure for providing an MBS service at the content server 860 in the broadband wireless communication system according to the second embodiment of the present invention.

Steps 1201 through 1211 in FIG. 12 are identical respectively to steps 701 through 711 in FIG. 7 and thus a description of steps 1201 through 1211 will be omitted for conciseness.

Referring to FIG. 12, the content server 860 transmits encrypted contents to the MBS controller 850 and then transmits a service initiation request message to the MBS controller 850, in step 1213. In step 1215, the content server 860 determines whether a content delivery report message for reporting termination of the content receipt is received from the user terminal 800. The content delivery report message includes accounting data, and examples of the accounting data include information about the user ID, the content ID, the broadcast receipt duration, and the receipt results indicating whether the contents have been normally received. If the content delivery report message is received from the user terminal 800, the content server 860 performs accounting for the MBS service on the basis of the information included in the content delivery report message and transmits a content delivery ACK message for the content delivery report to the user terminal 800 to inform the terminal 800 of the successful completion of the MBS service, in step 1217.

In step 1219, the content server 860 transmits a service release request message to the MBS controller 850 to report the termination of the MBS service. Thereafter, the procedure ends.

For example, the user terminal 800 and the base station 840 may establish a wireless connection such as a unicast connection for transmission of the broadcast contents.

As described above, the apparatus and method for providing an MBS service in the broadband wireless communication according to the present invention performs the process of establishing a previous connection for provision of the MBS service, the process of transmitting broadcast information, the process for registering in the corresponding content MBS service using the received broadcast information, and the process for transmitting content decryption information, thereby making it possible to activate the broadband wireless communication system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for receiving a Multicast/Broadcast Service (MBS) at a user terminal in a wireless communication system, comprising the steps of:
transmitting an MBS request message to a content server and receiving an MBS response message including broadcast information from the content server; and
establishing an MBS connection with a base station for a transmission of contents.

2. The method of claim 1, wherein the MBS request message includes user profile information.

3. The method of claim 1, wherein the MBS response message includes at least one of broadcast information, a user IDentification (ID), and a multicast Internet Protocol (IP) address.

4. The method of claim 1, wherein the broadcast information includes at least one of a content ID, a channel ID, a content name, a start time, a transmission time, a multicast IP address, a multicast Connection IDentification (CID), a start frame number, burst allocation information, a packet size, and accounting information.

5. The method of claim 1, further comprising:
when a request is made for a service to provide one or more contents, transmitting a content request message including IDs of corresponding contents to the content server; and
receiving the corresponding contents from an MBS controller.

6. The method of claim 5, wherein the received contents are encrypted contents.

7. The method of claim 6, further comprising receiving a content response message including a content protection key for decrypting the encrypted contents from the content server.

8. The method of claim 7, wherein the content response message includes at least one of the content protection key, a content ID, and a user ID.

9. The method of claim 5, wherein the content request message includes at least one of a content ID and a user ID.

10. The method of claim 5, further comprising:
when a request is made for a completion of the service of one or more contents, transmitting a content delivery report message including IDs of the corresponding contents to the content server; and
receiving a content delivery ACKnowledgment (ACK) message from the content server.

11. The method of claim 10, wherein the content delivery report message includes at least one of a user ID, a content ID, a broadcast receipt duration, and broadcast receipt results.

12. The method of claim 10, further comprising releasing the MBS connection with the base station through a Dynamic Service Deletion (DSD) process.

13. The method of claim 1, wherein the step of establishing the MBS connection comprises:
transmitting a Dynamic Service Addition (DSA) request message including a multicast IP address to the base station; and
receiving a DSA response message including a multicast CID mapped to the multicast IP address from the base station.

14. The method of claim 1, wherein the step of establishing the MBS connection comprises:
receiving a DSA request message including a multicast CID from the base station; and
generating and transmitting a DSA response message to the base station.

15. A method for providing a Multicast/Broadcast Service (MBS) at a base station in a wireless communication system, comprising the steps of:
when a burst reservation request message for an MBS burst is received from an MBS controller, allocating the MBS burst to an MBS traffic transmission period; and
establishing an MBS connection with a user terminal for content transmission.

16. The method of claim 15, wherein the burst reservation request message includes at least one of information about an Orthogonal Frequency Division Multiple Access (OFDMA) symbol offset of the MBS burst, information about an offset of a subchannel for transmitting the MBS burst, boosting information, information about a number of OFDMA symbols occupied by the MBS burst, information about a number of subchannels for transmitting the MBS burst, information about a repetition coding indication, information about a start of a frame number indicating the frame number for transmitting the MBS burst, information about an MBS frame duration, and information about a multicast CID.

17. The method of claim 15, further comprising transmitting a burst reservation ACK message to the MBS controller.

18. The method of claim 15, wherein the step of establishing the MBS connection comprises:
receiving a Dynamic Service Addition (DSA) request message including a multicast IP address from the user terminal; and
transmitting a DSA response message including a multicast CID mapped to the multicast IP address to the user terminal.

19. The method of claim 15, wherein the step of establishing the MBS connection comprises:
transmitting a DSA request message including a multicast CID to the user terminal; and
receiving a DSA response message from the user terminal.

20. The method of claim 19, wherein the MBS connection is established when an MBS initiation request message is received from the MBS controller.

21. The method of claim 20, further comprising sending an MBS initiation response message to the MBS controller.

22. The method of claim 19, further comprising:
when an MBS release request message is received from the MBS controller, releasing the MBS connection with the user terminal through a Dynamic Service Deletion (DSD) process; and
transmitting an MBS release response message to the MBS controller.

23. A method for providing a Multicast/Broadcast Service (MBS) at an MBS controller in a wireless communication system, comprising the steps of:
receiving broadcast information from a content server;
allocating an MBS burst on a basis of the received broadcast information; and
generating and transmitting a burst reservation request message including MBS burst allocation information to a base station.

24. The method of claim 23, wherein the broadcast information includes at least one of a content ID, a channel ID, a content name, a start time, a transmission time, a multicast IP address, a multicast connection ID (CID), a start frame number, burst allocation information, a packet size, and accounting information.

25. The method of claim 23, wherein the burst reservation request message includes at least one of information about an Orthogonal Frequency Division Multiple Access (OFDMA) symbol offset of the MBS burst, information about an offset of a subchannel for transmitting the MBS burst, boosting information, information about a number of OFDMA symbols occupied by the MBS burst, information about a number of subchannels for transmitting the MBS burst, information about a repetition coding indication, information about a start frame number indicating a frame number for transmitting the MBS burst, information about an MBS frame duration, and information about a multicast CID.

26. The method of claim 23, further comprising allocating a multicast CID for each content on a basis of the received broadcast information.

27. The method of claim 23, further comprising receiving a burst reservation ACK message from the base station.

28. The method of claim 23, further comprising receiving contents from the content server and performing a packetization and a time-stamping on the received contents.

29. The method of claim 28, further comprising transmitting the packetized and time-stamped contents to a user terminal.

30. The method of claim 28, further comprising:
receiving a service initiation request message from the content server and transmitting an MBS initiation request message to the base station; and
when an MBS initiation response message is received from the base station, transmitting the packetized and time-stamped contents to a user terminal.

31. The method of claim 30, further comprising receiving a service release request message from the content server, transmitting an MBS release request message to the base station, and receiving an MBS release response message from the base station.

32. A method for providing a Multicast/Broadcast Service (MBS) at a content server in a wireless communication system, comprising the steps of:
when contents are received from a content provider, generating a service guide using the received contents;
when an MBS request message is received from a user terminal, transmitting an MBS response message including the generated service guide to the user terminal; and
when a content request message for one or more contents is received from the user terminal, transmitting corresponding contents to an MBS controller.

33. The method of claim 32, wherein the MBS request message includes user profile information.

34. The method of claim 32, wherein the MBS response message includes at least one of the service guide, a user ID, and a multicast IP address.

35. The method of claim 32, wherein the service guide includes at least one of a content ID, a channel ID, a content name, a start time, a transmission time, a multicast IP address, a multicast Connection IDentification (CID), a start frame number, burst allocation information, a packet size, and accounting information.

36. The method of claim 32, further comprising transmitting the generated service guide to the MBS controller.

37. The method of claim 32, further comprising performing a user authentication and a service registration on the user terminal using user profile information included in the MBS request message.

38. The method of claim 32, wherein the content request message includes at least one of a content ID and a user ID.

39. The method of claim 32, wherein the step of transmitting the contents to the MBS controller comprises:
when a content request message for one or more contents is received from the user terminal, encrypting the received contents and generating a content protection key for decrypting the encrypted contents;
transmitting a content response message including the generated content protection key to the user terminal; and
transmitting the encrypted contents to the MBS controller.

40. The method of claim 39, wherein the content response message includes at least one of the content protection key, a content ID, and a user ID.

41. The method of claim 32, further comprising:
when a content delivery report message is received from the user terminal, performing an accounting on corresponding MBS service; and
transmitting a content delivery ACK message to the user terminal.

42. The method of claim 41, wherein the content delivery report message includes at least one of a content ID, a user ID, a broadcast receipt duration, and broadcast receipt results.

43. The method of claim 41, further comprising transmitting a service release request message to the MBS controller.

44. The method of claim 32, further comprising transmitting a service initiation request message to the MBS controller after the step of transmitting the corresponding contents to the MBS controller.

45. An apparatus for providing a Multicast/Broadcast Service (MBS) in a wireless communication system, comprising:
a user terminal that transmits/receives an MBS request message/an MBS response message and establishes an MBS connection with a base station for a content transmission; and
a content server that, upon receiving contents from a content provider, generates a service guide using the received contents and, upon receiving the MBS request message from the user terminal, performs a user authentication and a service registration on the user terminal and then transmits the MBS response message including the generated service guide to the user terminal.

46. The apparatus of claim 45, wherein
when a request is made for a service to provide one or more contents, the user terminal transmits a content request message including IDs of the contents to the content server and then receives the contents from an MBS controller; and
the content server transmits the contents to the MBS controller upon receiving the content request message from the user terminal.

47. The apparatus of claim 46, wherein, upon receiving the content request message from the user terminal, the content server encrypts the received contents, generates a content protection key for decrypting the encrypted contents, and transmits a content response message including the generated content protection key to the user terminal.

48. The apparatus of claim 46, wherein
the content server transmits the generated service guide to the MBS controller;
the MBS controller receives the transmitted service guide from the content server, allocates an MBS burst on the basis of the received service guide, and generates/transmits a burst reservation request message including the MBS burst allocation information to the base station; and
the base station allocates the MBS service burst to an MBS traffic transmission period upon receiving the burst reservation request message from the MBS controller.

49. The apparatus of claim 46, wherein, upon receiving the contents from the content server, the MBS controller performs a packetization and a time-stamping on the received contents and transmits the packetized and time-stamped contents to the user terminal.

50. The apparatus of claim 46, wherein
when a request is made for a completion of the contents, the user terminal transmits a content delivery report message including the IDs of the contents to the content server and receives a content delivery ACK message from the content server; and
upon receiving the content delivery report message from the user terminal, the content server performs an accounting on the corresponding MBS service and transmits the content delivery ACK message to the user terminal.

51. The apparatus of claim 49, wherein
the content server transmits a service initiation request message to the MBS controller after the transmission of the packetized and time-stamped contents to the user terminal;
the MBS controller transmits an MBS initiation request message to the base station upon receiving the service initiation request message from the content server, and transmits the packetized and time-stamped contents to the user terminal upon receiving an MBS initiation response message from the base station; and
upon receiving the MBS initiation request message from the MBS controller, the base station establishes the MBS connection with the user terminal for content transmission and transmits the MBS initiation response message to the MBS controller.

52. The apparatus of claim 50, wherein
the content server transmits a service release request message to the MBS controller;
the MBS controller transmits an MBS release request message to the base station upon receiving the service release request message from the content server; and
the base station releases the MBS connection with the user terminal through a Dynamic Service Deletion (DSD) process upon receiving the MBS release request message from the MBS controller.

53. The apparatus of claim 45, wherein the service guide includes at least one of a content ID, a channel ID, a content name, a start time, a transmission time, a multicast IP address, a multicast Connection IDentification (CID), a start frame number, burst allocation information, a packet size, and accounting information.
